(19) United States
(12) Patent Application Publication
(10) Pub. No.: US 2005/0136863 A1
(43) Pub. Date: Jun. 23, 2005

(54) Micro-wave signals detector

(75) Inventor: Chi-Shen Shan, YungHo City (TW)

Correspondence Address: Troxell Law Office PLLC, Suite 1404, 5205 Leesburg Pike, Falls Church, VA, 22041, US

(73) Assignee: Chuang Guan Technology Co., Ltd.

(21) Appl. No.: 10/740,626

(22) Filed: Dec. 22, 2003

(51) Int. Cl. H04B 1/04

(52) U.S. Cl. 455/126

(57) ABSTRACT

The present invention relates to a micro-wave signals detector. It comprises a receiving unit, an outputting unit, a processing unit and a displaying unit. At first, the processing unit initiates the setting and the adjustment for the outputting unit so as to allow the outputting unit amplifies, and shapes micro-wave signals received by the receiving unit, then the amplified and shaped micro-wave signals sent to the processing unit, The processing unit calculates the micro-wave signals and sends to the displaying unit to show the results, the present invention measures not only the frequencies intensity of each channel in order to enhance and adjust the quality when establishing a wireless system but also the scope of communication to provide that maximum usage rate and guarantee the communication quality.

### FIELD OF THE INVENTION

The present invention relates to a micro-wave signals detector, which can detect the intensity of micro-wave signals of each channel, and it can not only enhance and adjust the quality of each channel when establishing the wireless system but also measure the communication scope to provide the maximum usage rate and guarantee the communication quality when using the wireless system.

### BACKGROUND OF THE INVENTION

As each Government concluded the frequency for wireless communication and most frequencies can be used if and only if licenses. However, the frequencies for public usage in Industrial, Scientific and Medical band can be use without licenses. The frequencies that each Government release is not the same, generally speaking, all Governments release the frequencies depending on the standard of FCC (Federal Communications Committee). Basing on the version of FCC published on Oct. 01 2001, the frequencies for public usage are 902 to 928 MHz, 2400 to 2483.5 MHz and 5725 to 5850 MHz, called ISM (Industrial, Scientific and Medical) Band.

However, even most Governments release the public usage frequencies depending on the standard of FCC, there are still have some differences among all Governments and it becomes the incompatible source in communication. As the band with 2.4 GHz to 2.5 GHz, for example, the frequencies are 2400 to 2483.5 MHz in USA, Canada and Middle-South America, the frequencies in some countries of Europe are 2400 MHz to 2483.5 MHz, and the frequencies in France are 2446.5 MHz to 2483.5 MHz, however, the frequencies in some districts of Japan are 2471 MHz to 2497 MHz.

The frequencies each Government releasing for public usage are different, so, a user moves from France to Germany or from Japan to Europe, the user can't use the original communication device immediately. It is not the will to release the ISM band for public usage, hence, there are some solutions provided to solve such communication problems among different frequencies when users move among different countries.

The U.S. Pat. No. 5,867,766 disclosed a technology applying in a wireless device; this technology allows the wireless device can search all usable frequencies and switch among the usable frequencies automatically. The device can search all usable bands and switch to the suitable band when the original frequency fill with noises or with low power problem. The emitting side connects to the receiving side depending on the frequencies that local Government releases.

The U.S. Pat. No. 6,556,825 disclosed a device to detect and to switch the frequencies depending on which country the user locating and it allows the emitting side communicates with the receiving side without any manual adjustment.

However, all solutions described above focus on the communication problem among different countries. What all solutions detecting is total energy and intensity of RF signals each band instead of each channel, it is useless to improve the communication quality.

Please refer to the FIG. 1 is the sketch of the system structure of a prior signals detector. The signals detector comprises an antenna 11, a band filter 12, a local oscillator 13, a DC calibration 14, an Analog/Digital converter 15, a microprocessor 16, and a LED (Light Emitting Diode) 17.

The band filter 12 filters out the required band after the antenna 11 receiving microwave signals; the local oscillator 13 controls the frequencies of the band to provide the accurate frequencies. The DC calibration 14 gets required signals out and transfers these signals to analog form then it sends these analog signals to an Analog/Digital converter 15 after fixing the required frequencies. The Analog/Digital converter 15 transfers the signals coming from the DC calibration 14 from analog signals to digital signals then the microprocessor 16 processes the digital signals coming from the Analog/Digital converter 15.

The microprocessor 16 sends the processed result to a LED 17 then the LED 17 display the detecting result to user.

However, the Local Oscillator applying in prior signals detector is fixing in a frequency and it can't be changed, it detects the whole energy of each band instead of each channel. User can't know the detail status of each channel and use all usable channels. Hence, the structure of prior signals detector needed to be improved.

### SUMMARY OF THE INVENTION

The present invention relates to a microwave signals detector, the first objective is to detect the signals intensity of each channel then it enhances and adjusts the quality of each channel when establishing a wireless system.

The present invention relates to a micro-wave signals detector, the secondary objective is to detect signals of each channel and gets the communication scope in order to provide the maximum usage rate thus it can guarantee the communication quality when establishing the wireless system.

The present invention relates to a micro-wave signals system comprises a receiving unit; an outputting unit amplifies and shapes the micro-wave signals coming from the receiving unit then sends the processed signals to a processing unit, the processing unit processes the signals coming from the outputting unit then sends the result to both the outputting unit and a displaying unit, the displaying unit shows the result coming from the processing unit.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawing, which is incorporated in and constitutes a part of this specification, illustrates several embodiments of the invention and together with the description, serves to explain the principles of the invention.

### BRIEF DESCRIPTION OF THE DRAWINGS

FIG. 1 is a sketch of the structure of a prior signal detector;

FIG. 2 is a sketch of the structure of the present invention.

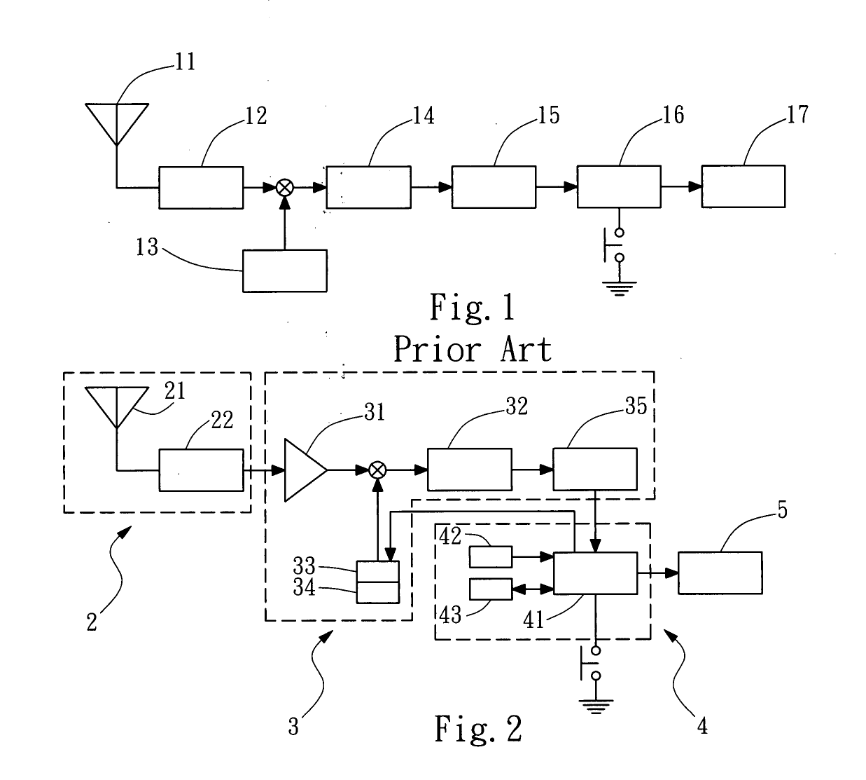

### DESCRIPTION OF THE EMBODIMENTS

Please refer to FIG. 2 is a sketch of the structure of the present invention. The micro-wave signals detector of the present invention comprises a receiving unit 2, an outputting unit 3, a processing unit 4 and a displaying unit 5, wherein the receiving unit 2 further including an antenna 21 and a ISM (Industrial, Scientific and Medical) band filter 22, the receiving unit 2 receives micro-wave signals via the antenna 21 and gets the required band out via the band filter22.

The outputting unit 3 further comprises a low noise amplifier 31, a DC calibration 32, a Voltage Controlled Oscillator 33, a PLL 34 and an Analog/Digital converter 35. The low noise amplifier 31 of the outputting unit 3 amplifies the signals coming from the Industrial, Scientific and Medical band filter 22, the low noise amplifier 31 amplifies the signal only, it do not amplify noises simultaneously, that is different from other amplifiers and signals amplified by such amplifier are much clean, then the Voltage Controlled Oscillator 33 controls which frequencies needed to be got out then the PLL 34 fixes and adjusts the differential of frequencies phase to provide the accurate frequencies and channels. After fixing the frequency, the DC calibration 32 gets out the original signals and transfers to analog signals then it sends the analog signals to the Analog/Digital Converter 35, the Analog/Digital Converter 35 transfers the signals coming from the DC calibration 32 from analog signals to digital signals.

The processing unit 4 further comprises the microprocessor 41, ROM (Read Only Memory) 42 and RAM (Random Access Memory) 43, the microprocessor 41 of the processing unit 4 processes the digital signals coming from the Analog/Digital Converter 35, there are some programming codes storing in the ROM 42 and microprocessor 41 processes the data after accessing the programming codes stored in ROM 42 and stores the calculation parameters in RAM 43 in order to access and record the calculation parameters temporality. The microprocessor 41 outputs the processed signals to the displaying unit 5.

The displaying unit 5 shows the processed results coming from the processor 4 and shows the signals intensity of channels on a LED (Light Emitting Diode) or a LCD (Liquid Crystal Display).

Furthermore, the processor 41 described above sends a feedback signal to the Voltage Controlled Oscillator 33 after processed in order to change the frequency produced by Voltage Controlled Oscillator 33 to get out the different frequencies then it repeats such circulations and user can get the frequencies intensity of all channels by detecting processes described above.

Due to the frequencies and energy of signals of each channel can be detected by the present invention and further analyzes which signals of channel are too weak and needed to be enhanced in order to improve the communication quality, hence, the present invention can be applied to measure the scope while establishing a wireless system in order to provide the maximum usage rate and guarantee the communication quality.

It is to be understood that while the invention has been described above in conjunction with preferred specific embodiments, the description and examples are intended to illustrate and not limit the scope of the invention, which is defined by the scope of the appended claims.

1. A micro-wave signals detector comprising:
a receiving unit;
an outputting unit;
a processing unit; and
a displaying unit;
wherein the outputting unit amplifying and shaping the receiving signals coming from receiving unit then sending the signals to the processing unit; the processing unit sending the processed signals to the displaying unit and the processing unit sending a feedback signals to the outputting unit to change the frequencies in order to get the signals out from different frequencies and it measuring another frequencies via the receiving unit in order to detect all signals of all frequency bands repeatedly.

2. The micro-wave signals detector as described in claim 1, wherein the receiving unit comprising: an antenna and a band filter.

3. The micro-wave signals detector as described in claim 2, wherein the frequency band filter can be an ISM band filter.

4. The micro-wave signals detector as described in claim 1, wherein the outputting unit comprising a low noise amplifier, a DC calibration, a Voltage Controlled Oscillator, a PLL and an Analog/Digital converter.

5. The micro-wave signals detector as described in claim 1, wherein the processing unit comprising a microprocessor, a ROM and a RAM.

6. The micro-wave signals detector as described in claim 1, wherein the displaying unit can be a LED.

7. The micro-wave signals detector as described in claim 1, wherein the displaying unit can be a LCD.
